(19) United States
(12) Patent Application Publication
(10) Pub. No.: US 2025/0329819 A1
(43) Pub. Date: Oct. 23, 2025

(54) BATTERY MODULE AND METHOD OF MANUFACTURING THE SAME

(71) Applicant: SAMSUNG SDI CO., LTD., Yongin-si (KR)

(72) Inventor: Martin BLODER, Sinabelkirchen (AT)

(21) Appl. No.: 18/888,726

(22) Filed: Sep. 18, 2024

(30) Foreign Application Priority Data
Apr. 18, 2024 (EP) 24170933.6

(51) Int. Cl. H01M 10/6556; H01M 50/209; H01M 50/238; H01M 50/249; H01M 50/262; H01M 50/30

(52) U.S. Cl. CPC H01M 10/6556; H01M 50/209; H01M 50/238; H01M 50/249; H01M 50/262; H01M 50/30

(57) ABSTRACT

A battery module includes battery cells; and a frame including a bottom member, side walls, and at least two top flap portions, which form a space for accommodating the battery cells, wherein at least two side walls are bent and extended from the bottom member, wherein the at least two top flap portions are bent and extended from the at least two side walls to extend towards each other, wherein the at least two side walls, the at least two top flap portions, and the bottom member are formed by a plate including a first metal sheet on an inner side of the plate and a second metal sheet on an outer side of the plate, and wherein the plate further includes at least one cooling channel in at least one of the at least two side walls.

### CROSS-REFERENCE TO RELATED APPLICATION

The present application claims priority to and the benefit of European Patent Application Ser. No. 24/170,933.6, filed on Apr. 18, 2024, in the European Patent Office, the entire disclosure of which is incorporated herein by reference.

### BACKGROUND

### 1. Field

Aspects of the present disclosure relate to a battery module and a method of manufacturing the same. In addition, aspects of the present disclosure relate to a battery system including the battery module, and a vehicle including the battery system.

### 2. Description of the Related Art

Recently, vehicles for transportation of goods and people have been developed that use electric power as a source for motion. Such an electric vehicle is an automobile that is propelled permanently or temporarily by an electric motor, using energy stored in rechargeable batteries. An electric vehicle may be solely powered by batteries (as in the case of a battery electric vehicle (BEV)) or may include a combination of an electric motor and, for example, a conventional combustion engine (as in the case of a plugin hybrid electric vehicle (PHEV)). BEVs and PHEVs use high-capacity rechargeable batteries, which are designed to provide power for propulsion over sustained periods of time.

Generally, a rechargeable (or secondary) battery cell includes an electrode assembly including a positive electrode, a negative electrode, and a separator interposed between the electrodes. A solid or liquid electrolyte allows movement of ions during charging and discharging of the battery cell. The electrode assembly is located in a casing, and electrode terminals, which are positioned on the outside of the casing, establish an electrically conductive connection to the electrodes. The shape of the casing may be, for example, cylindrical or rectangular.

A battery module is formed of a plurality of battery cells connected together in series or in parallel or a combination of the two. That is, the battery module is formed by interconnecting the electrode terminals of the plurality of battery cells depending on a desired amount of power and in order to realize a high-power rechargeable battery.

Battery modules can be constructed in either a block design or in a modular design. In the block design each battery cell is coupled to a common current collector structure and a common battery management system and the unit thereof is arranged in a housing. In the modular design, pluralities of battery cells are connected together to form submodules and several submodules are connected together to form the battery module. In automotive applications, battery systems generally include a plurality of battery modules connected together in series to provide a desired voltage.

A battery pack is a set of any number of (e.g., identical) battery modules or single battery cells. The battery modules, and constituent battery cells, may be configured in a series, parallel or a mixture of both to deliver the desired voltage, capacity, and/or power density. Components of a battery pack include the individual battery modules, and the interconnects, which provide electrical conductivity between the battery modules.

The mechanical integration of a battery pack utilizes appropriate mechanical connections between the individual components, (of e.g., battery modules) and between them and a supporting structure of the vehicle. These connections must remain functional and safe during the average service life of the battery system. Further, installation space and interchangeability requirements must be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors such as bolts or screws. Alternatively, the battery modules are confined by fastening side plates to lateral sides of the carrier framework. Further, cover plates may be fixed atop and below the battery modules.

The carrier framework of the battery pack is mounted to a carrying structure of the vehicle. In an example in which the battery pack is fixed at the bottom of the vehicle, the mechanical connection may be established from the bottom side by, for example, bolts passing through the carrier framework of the battery pack. The framework is usually made of aluminum or an aluminum alloy to lower the total weight of the construction.

Battery systems according to the related art, despite any modular structure, usually include a battery housing that serves as an enclosure to seal the battery system against the environment and provides structural protection of the battery system's components. Housed battery systems are usually mounted as a whole into their application environment, for example, an electric vehicle. Thus, the replacement of defect system parts, for example, a defect battery submodule, involves dismounting the whole battery system and removal of its housing first. Even defects of small and/or cheap system parts might then lead to dismounting and replacement of the complete battery system and its repair after dismantlement. As high-capacity battery systems are expensive, large and heavy, said procedure may prove burdensome and the storage, for example, in the mechanic's workshop, of the bulky battery systems may become difficult.

An active or passive thermal management system may be included to provide thermal control of the battery pack, to safely use the at least one battery module by efficiently emitting, discharging, and/or dissipating heat generated from its rechargeable batteries. If the heat emission/discharge/dissipation is not sufficiently performed, temperature deviations may occur between respective battery cells, such that the at least one battery module may no longer generate a desired (or designed-for) amount of power. In addition, an increase of the internal temperature can lead to abnormal reactions occurring therein, and thus charging and discharging performance of the rechargeable battery deteriorates and the life-span of the rechargeable battery is shortened. Thus, cell cooling for effectively emitting/discharging/dissipating heat from the cells is desired.

Current battery modules of the related art either consist of solid structures which need additional cooling plates or are formed by extruded profiles both for the supporting frame as well as for the coolant channels.

However, battery modules which incorporate additional cooling plates into the battery module have an increased number of parts to be assembled. This implies that the assembly effort is increased such that the manufacturing of the battery modules requires additional assembly effort.

Battery modules which are produced through extruded profiles to build the frame and to incorporate the cooling channels therein requires complicated frame assembly operations. In addition, extruded profiles have inflexible cooling channel design limitations with generally rather limited cooling performance.

In both cases manufacturing costs are relatively high so that a reduction of costs is desirable with respect to the mentioned battery modules. In addition, more flexible cooling channel designs may be desired to improve the cooling performance of battery modules. Further, upper parts of the battery cells are regularly subject to overheating where, for example, the electrode terminals, busbar connections or wirings are located. Current battery modules and manufacturing methods often entirely avoid cell top covers for busbar cooling or for battery cell cooling. Other known methods provide incorporated cooler top members that are manufactured to the final dimensions prior to the fixation to a module frame.

However, battery modules according to the state of the art without any top cooling cover cannot provide fast charging due to heat development and low thermal propagation characteristics can be achieved. Furthermore, battery modules that use a more or less open busbar architecture are also prone to arcing and thermal propagation due to the electrically conductive deposits from battery cells in thermal runaway.

On the other hand, battery modules of the related art that use fully pre-manufactured top cooler covers struggle with inevitably varying heights of the individual cells and the surrounding frame. Such height variations may lead to uneven pressure and non-uniform cooling of the battery cells. This in turn reduces the overall performance and lifetime of the battery module or the system, which uses the battery modules.

The above information disclosed in this Background section is only for enhancement of understanding of the background of the invention and therefore it may contain information that does not form the prior art.

### SUMMARY

According to some aspects of the present disclosure, there is provided a battery module including: a plurality of battery cells; and a frame including a bottom member, a plurality of side walls, and at least two top flap portions, the bottom member, the plurality of side walls and the at least two top flap portions forming an interior accommodation space configured to accommodate the plurality of battery cells, wherein at least two side walls of the plurality of side walls that are opposite one another are bent and extended from the bottom member, wherein the at least two top flap portions are bent and extended from the at least two side walls to extend towards each other, wherein the at least two side walls, the at least two top flap portions, and the bottom member are formed by a plate including a first metal sheet on an inner side of the plate and a second metal sheet on an outer side of the plate, the first and second metal sheets being roll bonded to each other, and wherein the plate further includes at least one cooling channel in at least one of the at least two side walls, the at least two top flap portions and the bottom member formed between bonding areas of the first metal sheet and the second metal sheet.

In some embodiments, the at least one cooling channel includes at least one top cooling channel formed in the at least two top flap portions, and the at least two top flap portions are configured to elastically press the first metal sheet against the plurality of battery cells by inflating the at least two top flap portions for forming at least one top cooling channel.

In some embodiments, the at least one cooling channel is arranged to overlap with an electrode terminal of the plurality of battery cells, and the at least two top flap portions are configured to elastically press the first metal sheet against the electrode terminal of the plurality of battery cells by the inflating of the at least two top flap portions to form the at least one top cooling channel.

In some embodiments, the battery module further includes: a cell vent cover on the plurality of battery cells; and a gap formed between the at least two top flap portions extending towards each other, the gap overlapping with the cell vent cover. In some embodiments, the at least one top cooling channel is arranged to overlap with the cell vent cover, and the at least two top flap portions are configured to elastically press the first metal sheet against at least a portion of the cell vent cover to fix the cell vent cover by the inflating of at least two top flap portions for forming the at least one top cooling channel.

In some embodiments, the at least two top flap portions are configured to elastically press the first metal sheet against an edge portion of the cell vent cover.

In some embodiments, the electrode terminal and the cell vent cover are separated from each other at least one top cooling channel.

In some embodiments, the at least two top flap portions include a cross section profile with stepped portions between a flap tip portion and a peripheral portion, the flap tip portion being inwardly displaced with respect to the peripheral portion.

In some embodiments, bonding areas are formed in curved edges between the side walls and the at least two top flap portions.

According to some aspects of the present disclosure, there is provided a method of manufacturing a battery module, wherein the method includes: providing a plate by roll-bonding a first metal sheet with a second metal sheet; bending the plate so that at least two side walls opposite from each other are bent and extended from a bottom member and such that two top flap portions opposite from each other are bent and extended from the at least two side walls to extend towards each other; inserting a plurality of battery cells in an accommodation space formed at least by the bottom member, the at least two side walls and the two top flap portions; and inflating of the plate such that at least one cooling channel is formed in at least one of the at least two side walls, the two top flap portions, and the bottom member between bonding areas of the first metal sheet and the second metal sheet.

In some embodiments, the at least one cooling channel includes at least one top cooling channel formed in at least one of the two top flap portions, and wherein the inflating includes: inflating, after the plurality of battery cells are installed in the accommodation space formed at least by the bottom member, the two top flap portions to elastically press the first metal sheet against the plurality of battery cells for forming at least one top cooling channel between bonding areas of the first metal sheet and the second metal sheet.

In some embodiments, the method further includes: providing a cell vent cover including venting valves formed on the plurality of battery cells; and extending the two top flap portions towards each other so that a gap is formed which overlaps with the cell vent cover.

In some embodiments, two top flap portions include a cross section profile including an inwardly bent portion of a flap tip portion of the two top flap portions that is bent towards the plurality of battery cells in a state prior to inflating, and the inflating includes straightening of inwardly bent portion of the second metal sheet to a straight portion by elastically pressing the first metal sheet against the battery cells to form the at least one top cooling channel.

According to some aspects of the present disclosure, there is provided a battery system including the battery module described above.

According to some aspects of the present disclosure, there is provided a vehicle including the battery system described above.

### BRIEF DESCRIPTION OF THE DRAWINGS

Features will become apparent to those of ordinary skill in the art by describing in detail exemplary embodiments with reference to the attached drawings in which:

FIG. 1 illustrates a schematic perspective view of a battery module after inflating the top flap portions according to some embodiment of the present disclosure;

FIG. 2 illustrates a schematic side view of the battery module after inflating the top flap portions according to some embodiments of the present disclosure;

FIG. 3 illustrates a schematic perspective view of a battery module before inflating the top flap portions according to some embodiments of the present disclosure;

FIG. 4 illustrates a schematic side view of the battery module after inflating the top flap portions according to some embodiments of the present disclosure; and

FIG. 5 schematically illustrates a method of manufacturing a battery module according to some embodiments of the present disclosure.

### DETAILED DESCRIPTION

Reference will now be made in detail to some embodiments, examples of which are illustrated in the accompanying drawings. Effects and features of the exemplary embodiments, and implementation methods thereof will be described with reference to the accompanying drawings. In the drawings, like reference numerals denote like elements, and redundant descriptions are omitted. The present disclosure, however, may be embodied in various suitable forms, and should not be construed as being limited to only the illustrated embodiments herein. Rather, these embodiments are provided as examples so that this disclosure will be thorough and complete, and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. In the drawings, the relative sizes of elements, layers, and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” “comprising,” “has,” “have,” and “having,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, “in contact with”, “in direct contact with”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art. Further, if the term “substantially” is used in combination with a feature that could be expressed using a numeric value, the term “substantially” denotes a range of +/−5% of the value centered on the value. Furthermore, a specific quantity or range recited in this written description or the claims may also encompass the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

When one or more embodiments may be implemented differently, a specific process order may be performed differently from the described order. For example, (i) the disclosed operations of a process are merely examples, and may involve various additional operations not explicitly covered, and (ii) the temporal order of the operations may be varied.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification.

According to some aspects of the present disclosure, there is provided a battery module. The battery module includes a plurality of battery cells and a frame including a bottom member, a plurality of side walls and top flap portions. The bottom member, the plurality of side walls, and the least two top flap portions form an interior accommodation space in which the plurality of battery cells is accommodated. At least two side walls opposite from each other among the plurality of side walls are bent and extended from the bottom member. The at least two top flap portions are bent and extended from the at least two side walls to extend towards each other. The at least two side walls, the at least two top flap portions, and the bottom member are formed by a plate including a first metal sheet on an inner side of the plate and a second metal sheet on an outer side of the plate, which are roll bonded to each other. The plate further includes at least one cooling channel formed in at least one of the at least two side walls, the at least two top flap portions, and the bottom member between bonding areas where the first metal sheet and the second metal sheet are roll-bonded.

The side walls together with the bottom member and also the top flap portions constitute a frame, which may also be referred to as a case or casing. The roll bonding refers to particular form of connecting or bonding metal sheets with each other. In practice, two metal sheets are passed through a pair of flat rollers exposed to sufficient pressure to bond the metal sheets. The pressure is set high enough to deform the metals and reduce the combined thickness. The formation of the cooling channels by inflating may be provided by coating (e.g., with release agent or separation agent) a desired cooling channel layout on one among the metal sheets according to the desired cooling channels to be formed. Then, only the bare or uncoated metal surfaces bond in the roll bonding process. These areas may be referred to as the bonding areas. The un-bonded parts corresponding to the cooling channel layout are inflated, for example, through pressure and/or heating so that cooling channels can be formed in the plate. For the inflating, for example, a pressure generating device like a pump, a compressor, or other sources that can cause high fluid pressure may be connected to an end (e.g., a port) of the to-be inflated cooling channel (i.e., the unbonded areas) so that a fluid pressure (e.g., air or coolant pressure) causes inflation to form the at least one cooling channel. A limitation of the inflation can be achieved by the battery cells in a state where the battery cells are installed so that the inflation of the respective channel adapts and thus compensates the tolerances of the battery cells. In some examples, to reach a determined shape for the at least one cooling channel or the at least one crash channel, a contour defining member may be provided, which limits extension for the inflation and provides a defined shape. In order to connect the to-be-inflated cooling channel to the pressurized medium, a welded, soldered, or otherwise well-connected connection to the respective channel may be a desirable feature. To improve the connections, a hose sleeve or a pipe may be directly welded to the channel that is to be inflated. The metals of the first metal sheet and the second metal sheet may be the same metal or different metal. The roll-bonding thus allows the integration of cooling channels directly in the top cover member. Herein, the “inner side” may refer to the side directed to the accommodation space or the battery cells, and the “outer side” may refer to the side directed away from the accommodation space or the battery cells. A top flap portion may also be referred to as top flap or top portion.

Due to the double bending process on each side, the roll bonded sheet metal is converted into a frame. The frame may have a C-shape that is formed from a single piece plate. Incorporating suitably designed cooling channels on the bottom member, the top flap and/or the side walls can be manufactured at low costs providing integrated cooling and a great thermal propagation (e.g., heat transfer) performance due to the reduced thermal distance and because the cooling channel layout can be improved (e.g., optimized). Further, by extending the plate to the top of the battery module, the busbars as well as the cell top can be cooled with the same piece. Thus, a significant reduction of manufacturing effort and cost reduction can be achieved.

According to some embodiments, the at least one cooling channel includes at least one top cooling channel that is formed in at least one of the two top flap portions, wherein the at least two top flap portions are configured to elastically press the first metal sheet against the plurality of battery cells by inflating the at least two top flap portions for forming the at least one cooling channel. Thus, it is possible to create a gap-free mechanical fixture with lasting pre-tension that ensures both the best possible transfer of heat to the top flap portion together with the integrated cooling function. The pre-tension can be achieved by performing the inflating after the cell assembly, that is at least the battery cells and optionally busbars, sensors, busbar covers and/or cell vent cover is integrated into the roll-bonded frame, before inflating the top flap portions. Thus, height tolerances of the battery cells can be compensated for by achieving a uniform mechanical pressure with improved (e.g., increased) thermal conductivity. For example, each of the battery cells despite having different heights has a press contact with the top flap portions since the inflation balances such height differences. A self-setting of the thermal contacts is thus achieved over the tops of the plurality of battery cells.

According to some embodiments, the at least one top cooling channel is arranged to overlap with electrode terminals of the plurality of battery cells and top flap portion is configured to elastically press the first metal sheet against the electrode terminals of the plurality of battery cells by inflating of the plate to form the at least one top cooling channel. Thus, top cooling channels in the top flap portions are pressed directly onto the electrode terminals, where wirings and busbars may be connected. Thus, heat transfer performance is increased by selectively locating and pressing the top cooling channel onto the electrode terminal region to reduce the thermal distance and to increase cooling performance.

According to some embodiments, the battery module further includes a cell vent cover including vents formed on the plurality of battery cells. The battery module includes a gap formed between the two top flap portions extending towards each other. The gap overlaps with the cell vent cover and/or the vents. The vents may be referred to as safety vents. Thus, due the formed gap being located to overlap hot venting gases can be easily escaped via the gap despite of the presence of the two top flap portion and the integrated cooling channels therein. Thus, by simply sparing a gap, a venting function is provided while allowing a cooling function from the top and while no additional venting openings are needed.

According to some embodiments, the at least one cooling channel is formed to overlap with the cell vent cover, and the two opposing top flap portions are configured to elastically press the first metal sheet against at least a portion of the cell vent cover to fix the cell vent cover. This fixing is caused by the inflating of the top cover member to form the top cooling channel and the resulting pre-tension. Thus, the cell vent cover is held in place by the liquid cooled sheet metal, so that the thermal propagation (e.g., heat transfer) characteristics are superior to current state of the art developments. Thus, the cooling channels of the top flap portions are configured to press onto, and thereby fix, the cell vent cover. This also further improves the thermal propagation (e.g., heat transfer) performance. For example, the top cooling channels and the press contacts of the first metal sheets caused by inflation are located so to fixate the cell vent cover, which reduces the amount of assembly requirements and fixation.

According to some embodiments, the two opposing top flap portions are configured to elastically press the first metal sheet against an edge portion of the cell vent cover. Thus, the fixation of the cell vent cover is improved while the venting capability in a centre of the cell vent cover is maintained. This further improves thermal propagation (e.g., heat transfer) performance.

According to some embodiments, the electrode terminals and the venting cover are separated from each other by the at least one top cooling channel. Because at least one top cooling channel presses on the battery cell, it can be used as a sealing that prevents or substantially reduce the likelihood of hot gases from entering the electrode terminal area. In other words, the space in which the terminal electrodes are located and the space in which the venting cover is located are sealed with respect to each other (i.e., said spaces are sealed off from one another).

According to some embodiments, the two opposing top flap portions include a cross section profile with stepped portions between a flap tip portion and a peripheral portion. The flap top portion may be inwardly displaced with respect to the peripheral portion. Here, “inwardly displaced” may refer to being displaced in direction of the battery cells or the bottom member or to have a creasing contour. This pre-configuration of the two flap portions including the stepped portion takes into account the height difference between the peripheral region where the electrode terminals, busbars, and/or wirings are located and the central region, where only a comparably flat cell vent cover is provided. Thus, the stepped portion assists in reducing the amount of inflating needed in the central region to establish the press contact with the battery cells. Thus, the distance of the top flap portion to the battery cells due to the pre-formed stepped portion is reduced and made more homogenous as the contour of top flap portions including the stepped portion more closely resembles the contour of the battery cell.

According to some other aspects of the present disclosure, there is provided a method of manufacturing a battery module. The method includes providing a plate by roll-bonding a first metal sheet with a second metal sheet. The method further includes bending the plate so that at least two side walls opposite from each other are bent and extended from a bottom member and so that at least two top flap portions opposite from each other are bent and extended from the at least two side walls to extend towards each other. The method includes providing and/or inserting a plurality of battery cells in an accommodation space formed at least by the bottom member, the at least two side walls, and the at least two top flap portions. The method further includes the inflating of the plate such that at least one cooling channel is formed between bonding areas of the first metal sheet and the second metal sheet.

According to some embodiments, at least one bottom cooling channel on the bottom member and/or at least one side cooling channel on the side wall is formed by the inflating. In this case, inflating for the at least one bottom cooling channel and/or at least one side cooling channel is performed before installing the battery cells and/or the cell assembly. In this case, inflating may be performed against an auxiliary barrier. This may ensure homogeneous and equally expanded channels size. The auxiliary barrier may be removed after the inflating. Otherwise, that is, in a case without this order, it would be possible, for example, that left/right/top and bottom channels become inflated differently and thus would consume a different volume.

According to some embodiments, the at least one cooling channel includes at least one top cooling channel formed in at least one of the two top flap portions. In some embodiments, the method of manufacture includes inflating, after the plurality of battery cells are provided or installed in the accommodation space that is formed at least by the bottom member, the side walls, and the top flap portions to elastically press the first metal sheet against the plurality of battery cells for forming the at least one top cooling channel between bonding areas where the first metal sheet and the second metal sheet are roll-bonded. Thus, it is possible to create a gap-free mechanical fixture with lasting pre-tension that ensures both the best possible transfer of heat to the top flap portion together with the integrated cooling function. The pre-tension can be achieved by performing the inflating after the cell assembly, that is at least the battery cells and optionally busbars, sensors, busbar covers, and/or cell vent cover are integrated into the roll-bonded frame before inflating the top flap portions. Thus, height tolerances of the battery cells can be compensated for by achieving a uniform mechanical pressure with improved (e.g., increased) thermal conductivity. For example, each of the battery cells despite having different heights has a press contact with the top flap portions because the inflation balances such height differences. A self-setting of the thermal contact is thus achieved.

According to some embodiments, the method of manufacturing a battery module includes the providing a cell vent cover with a plurality of venting valves formed on the plurality of battery cells. The extending the two top flap portions towards each other so that a gap is formed which overlaps with the venting valves.

According to some embodiments, in the method of manufacturing a battery module, two top flap portions include a cross section profile including an inwardly bent portion at least in a flap end region of the two top flap portions that is arched towards the plurality of battery cells in a state prior to inflating. the manufacturing method includes inflating, which includes straightening of the inwardly bent portion of the second metal sheet to a straight portion by elastically pressing the first metal sheet against the battery cells to form the at least one cooling channel in the fixed state. By pre-forming the top flap portion including the curved down arc prior to inflating which is then straightened due to contact of the first metal sheet with the battery cell in the inflation an improved (e.g., increased) mechanical pressure against the battery cell can be achieved as result of the initially inwardly bent shape. The use of the inwardly bent portion ensures an improved mechanical pressure over the lifetime of the battery unit.

According to some others aspect of the disclosure, there is provided a battery system including the battery module. Thus, the above-mentioned desirable features if the battery module also apply to the battery system.

According to some other aspects of the disclosure, there is provided a vehicle including the battery system.

According to some embodiments, the first metal sheet has a first thickness less than a second thickness of the second metal sheet. For example, but not restricted thereto, the first thickness may be between about 0.5 mm to about 2 mm. For example but not restricted thereto, the second thickness may be about 3 mm to about 5 mm. Thus, the second metal sheet may provide structural integrity to the top cover member via its thickness while the first thinner metal sheet may be suitable for the cooling channel generation by inflation due to the reduced thickness.

According to some embodiments, the first metal sheet and the second metal sheet include different metals and/or different metal alloys. Thus, the inner side of the top cover member and the outer side of the top cover member can be separately designed according to a desired functionality. For example, it may be desirable for the inner side to have higher heat conductivity as it is closer to the heat generating battery cells while it may be desirable for the outer side of the top cover member to have more structural robustness to prevent or substantially reduce deformation. Thus, the roll bonding can be used to tailor the top cover member as desired.

According to some embodiments, the first metal sheet includes aluminum or an aluminum alloy and the second metal sheet includes a steel or a metal matrix composite. Steel can be produced on large scale and is thus better for large scale production of battery units. The metal matrix composite may include fibers or particles dispersed in the metallic matrix.

According to some embodiments, the first metal sheet has a thermal conductivity higher than the thermal conductivity of the second metal sheet. Thus, the inner first metal sheet may act as a heat conductor that transports heat away, thus also acting as a cooling channel.

According to some embodiments, additive particles are used in the roll-bonding. Thus, bonding may be strengthened to reinforce the frame while reducing the risk of delamination. For example, metallic particles or ceramic particles may be added during the roll bonding.

The additional features as mentioned in the context of describing embodiments with respect to the battery module can be combined with the above-described method resulting in the same desirable effects as described above.

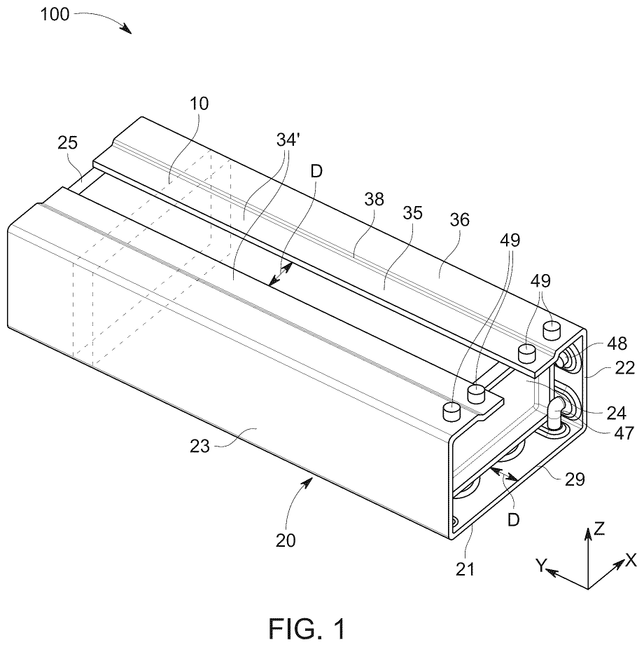

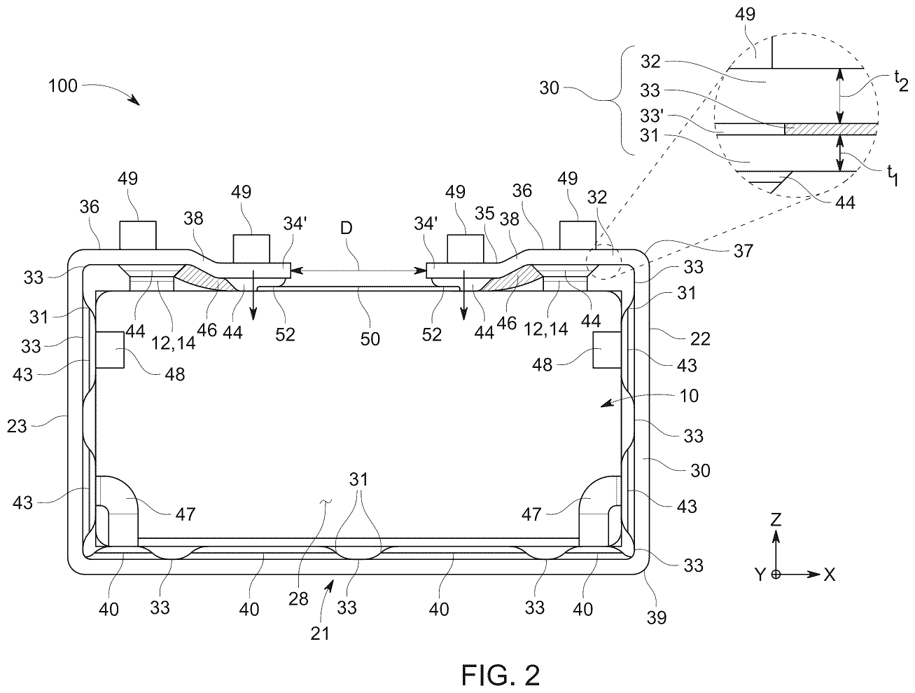

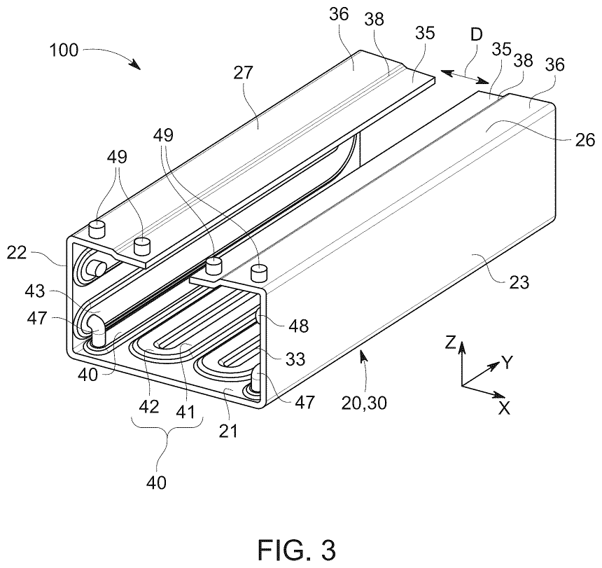

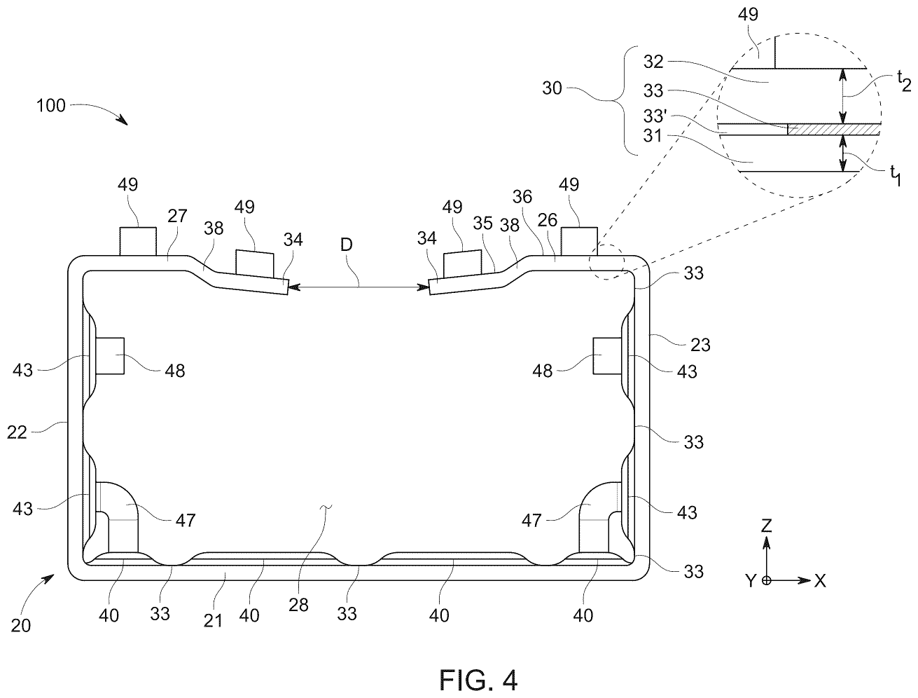

FIGS. 1 to 4 show a battery module 100, according to some embodiments of the present disclosure. FIGS. 1 and 2 show a schematic perspective view and a side view (when viewed in a y-direction) of a battery module 100 in a state after inflating of the top flap portions 26 and 27 including the battery cells 10. FIGS. 3 and 4 show a schematic perspective view and a side view (when viewed in a y-direction) of a battery module 100 in a state before inflation of the top flap portions 26 and 27 without the battery cells 10. In the following, the battery module 100 will be described with reference to the various FIGS. 1 to 4.

Referring now to FIGS. 1 to 2, the battery module 100 includes a plurality of battery cells 10. The battery cells 10 may each include a first electrode terminal 12 and a second electrode terminal 14 with opposite polarity (e.g., opposite electrical polarity). The first electrode terminal 12 and the second electrode terminal 14 may be provided on a top surface of the battery cells 10. The electrode terminals 12 and 14 are schematically shown in FIG. 2 from the side view. Further, the battery cells 10 may be interconnected in a suitable manner. For example, busbars may be provided and connected with the battery cells 10 and the electrode terminals 12 and 14 thereof. The plurality of battery cells 10 in the battery module 100 may be stacked together to form a battery cell stack. The battery cells 10 may be prismatic battery cells but the present disclosure is not restricted thereto.

The battery module 100 further includes a frame 20. The frame 20 surrounds and supports the plurality of battery cells 10 of the battery module 100. The frame 20 includes a bottom member 21 and a plurality of side walls 22, 23, 24, and 25, and least two top flap portions 26 and 27 as indicated in the respective FIGS. 1 to 4. The bottom member 21, the plurality of side walls 22, 23, 24, and 25, and the least two top flap portions 26 and 27 form an internal accommodation space 28 in which the plurality of battery cells 10 is accommodated.

The battery module 100, two opposite side walls 22 and 23 among the plurality of side walls 22, 23, 24, and 25 are bent and extended from the bottom member 21. The opposite side walls 22 and 23 may extend in perpendicular direction with respect to the bottom member 21.

Further, the at least two top flap portions 26 and 27 are respectively bent and extended from the at least two side walls 22 and 23. The two top flap portions 26 and 27 as indicated in the FIGS. 1-4 form a top portion. The at least two top flap portions 26 and 27 extend towards each other. The at least two top flap portions 26 and 27 may extend parallel to the bottom member 21. Thus, a C-formed portion of the frame 20 can be provided by a double bending process. Thus, due to bending, the manufacturing costs can be reduced and the frame 20 can be easily produced.

The at least two side walls 22 and 23, the at least two top flap portions 26 and 27 and the bottom member 21 are formed by a plate 30. The plate 30 is twice bent and extended as described above on the two sides. The plate 30 further includes a first metal sheet 31 on an inner side of the plate 30. Further, the plate 30 includes a second metal sheet 32 on an outer side of the plate 30. The first metal sheet 31 and the second metal sheet 32 are roll bonded with each other.

The plate 30 further includes at least one cooling channel 40, 43, and 44 in at least one of the at least two side walls 22 and 23, the at least two top flap portions 26 and 27 and/or the bottom member 21. The at least one cooling channel 40, 43, and 44 may be formed by inflation of the plate 30, for example, by applying pressure to the unbonded areas 33′. That is, cooling channels 40, 43, and 44 can be formed in unbonded areas 33′ between bonding areas 33 where the first metal sheet 31 and the second metal sheet 32 are roll-bonded to each other.

As shown in FIGS. 1 to 4, in some examples, bottom cooling channels 40 are provided in the bottom member 21. In some examples, the bottom cooling channels 40 may include a plurality of parallel extending straight portions 41 connected to each other by curved end portions 42. The curved end portions 42 may be formed at ends of the bottom cooling channel 40. Furthermore, side cooling channels 43 are provided in the side walls 22 and 23 of the frame 20. The bottom cooling channels 40 and the side cooling channels 43 may be connected with each other by a side connection portion 47. The side cooling channels 43 may be formed to have the same shape as the bottom cooling channels 40.

In FIGS. 3 and 4, the top flap portions 26 and 27 are still bare and do not include any top cooling channels in a state before inflation, while FIGS. 1 and 2 show a battery module 100 including top cooling channels 44 in a state after inflation of the top flap portions 26 and 27.

Thus, the roll bonding allows for a direct integration of cooling functions within the frame 20 providing sufficient thermal propagation performance. In any of the at least two side walls 24 and 26, the at least two top flap portions 26 and 27, and the bottom member 21 cooling channels 40, 43, and 44 may be formed in the frame 20 according to various embodiments.

As shown in the embodiments of FIGS. 1 and 2, the at least two top flap portions 26 and 27 include an integrated cooling function. This enables the battery module 100 to effectively cool the plurality of battery cells 10 from the top side.

Referring to FIGS. 1 and 2, the top cooling channels 44 are formed by inflating the top flap portions 26 and 27. The inflating may be performed in a state where the plurality of battery cells 10 are inserted and/or installed in the accommodation space 28.

Thus, as shown in the examples of FIGS. 3 and 4 where the battery cells 10 are not yet included, only the side cooling channels 43 and/or bottom cooling channels 40 are formed while in the top flap portions 26 and 27 no top cooling channels 44 are included at this stage.

As illustrated in FIGS. 3 and 4, the top flap portions 26 and 27 are suitably pre-formed or prepared to provide the designated top cooling channels 44. Further, the flap portions 26 and 27 can provide a uniform contact pressure on the plurality of battery cells 10 as will be explained further below. The flap portions 26 and 27 in the state shown in FIGS. 3 and 4 may include a coated cooling channel layout at which unbonded areas 33′ are provided for forming the top cooling channels 44, and/or other cooling channels, by inflating.

Due to the inflation of the unbonded areas 33′ between bonded areas 33 where the first metal sheet 31 and the second metal sheets 32 are roll-bonded, the first metal sheet 31 of the top flap portions 26 and 27 elastically deforms and presses against the plurality of battery cells 10 while forming the top cooling channels 44. Thus, the top cooling channels 44 are formed by inflating while at the same time the top cooling channels 44, or the first metal sheet 31, exerts an elastic force onto the plurality of battery cells 10. Therefore, as indicated in FIG. 2 by several arrows, the first metal sheet 31 presses on the battery cells 10 from a top direction in the final state. Thus, due to the elastic deformation of the top flap portions 26 and 27 of the frame 20 until the battery cells 10 limit the expansion, an improved (e.g., increased) thermal propagation (e.g., heat transfer) is provided in the inflated state.

Because the inflating is performed with the battery cells 10 in the frame 20, that is, the performing the inflating occurs after a cell assembly including at least the battery cells 10 and optionally busbars, sensors, busbar, covers and/or cell vent cover 50 being installed into the roll-bonded frame 20 before inflating the top flap portions 26 and 27. Thus, height tolerances of the battery cells can be compensated by achieving a uniform mechanical pressure with improved thermal conductivity production height tolerances of the battery cells 10 are compensated for and a uniform mechanical pressure is achieved in the inflated state. Thus, each of the battery cells 10 despite having different heights has a reliable press contact with the top flap portions 26 and 27 because the inflation can balance such height differences. Therefore, a self-setting of the thermal contact is achieved because the top cooling channels 44 are automatically adapting to the varying heights of the individual battery cells 10 including busbar covers and other members improving cooling performance from the top side direction.

Further, referring to FIGS. 3 and 4, the top flap portions 26 and 27 includes a straight portion 34′ on the outer side of the plate 30. The straight portion 34′ is formed by inflating the pre-formed top flap portions 26 and 27 to elastically press the first metal sheet 31 against the battery cells 10. That is, when viewing FIGS. 3 and 4, the top flap portions 26 and 27 in a state prior to the inflating includes a cross section profile with an inwardly bent portion 34. The inwardly bent portion 34 is located in a flap tip portion 35 and is inwardly bent towards the plurality of battery cells 10. Thus, due to the inwardly bent portion 34 used before inflating, the contact formed can easily have a lasting pre-tension that ensures both improved (e.g., increased) thermal conductance and vibration resistance in the final state after inflating.

In some examples, when referring to FIG. 2, the inwardly bent portion 34 after inflation of the top flap portions 26 and 27 is straightened due to lifting of the second metal sheet 32 once the first metal sheet 31 contacts the battery cell 10 in the inflating process. For example, as shown in FIG. 2, the straight portion 34′ extends parallel to the bottom member 21. The straightening is caused by elastically pressing the first metal sheet 31, that is deformed due to inflation in direction of the battery cells 10, against the battery cells 10 to form the top cooling channels 44.

Referring to FIGS. 1 to 2 in which the inflation for forming the top cooling channels 44 is already performed in the at least two top flap portions 26 and 27. In the present example, two separate top cooling channels 44 are provided but the present disclosure is not restricted thereto. For example, a single continuous top cooling channel 44 may be provided or multiple separate top cooling channels 44. A top connecting portion 46 is exemplarily indicated in FIG. 2 connecting two straight portions of the respective top cooling channel 44. Further, top cooling channel ports 49 are indicated on the outer side of the top flap portions 26 and 27 from which coolant can be drained from the top cooling channels 44 or supplied thereto, respectively.

The at least two top flap portions 26 and 27 elastically press the first metal sheet 31 against the plurality of battery cells 10. The elastic pressing contact is achieved by inflating the at least two top flap portions 26 and 27 for forming the top cooling channels 44. Thus, a lasting pre-tension is provided that ensures both better heat transfer performance and vibration resistance.

As shown in FIGS. 1 and 2, the top cooling channel 44 is formed and positioned to overlap with electrode terminals 12 and 14 of the plurality of battery cells 10. The at least two top flap portions 26 and 27 are located to elastically press the first metal sheet 31 against the electrode terminals 12 and 14 by the inflating of the at least two top flap portions 26 and 27 to form the at least one top cooling channel 44. Thus, the thermal propagation performance is improved because heat of the terminal area of the battery cells 10, where the busbars or additional wiring are connected, can be easily carried away.

The battery module 100 may further include a cell vent cover 50. The cell vent cover 50 disposed (e.g., arranged/positioned/located) on the plurality of battery cells 50. The cell vent cover 50 is for example illustrated in FIG. 2. The cell vent cover 10 may allow releasing hot gases in a designated and safe manner to prevent or substantially reduce the likelihood of high pressure buildup and may protect neighboring battery cells 10 from the hot gases in such a case. The cell vent cover 50 in this case may be a single cover that spans the entirety of the plurality of battery cells 10 but can also be individually provided for each battery cell 10. The cell vent cover 50 may surround or cover cell vents of the respective battery cells 10. For example, the cell vent may be centrally covered, that is, surrounded, by the cell vent cover 50.

Referring to FIGS. 1 to 4, a gap D may be formed between the at least two top flap portions 26 and 27, which extend towards each other. Thus, the gap D may be formed between the flap tip portions 35 of the two opposing top flap portions 26 and 27. The gap D overlaps with the cell vent cover 50. Thus, due to the gap D formed between the two opposing top flap portions 26 and 27, hot gases released by the cell vents through the cell vent cover 50 can directly pass the gap D to the exterior of the battery module 100. Thus, a venting function is promoted while providing a cooling from the top side.

As shown in FIG. 2, the top cooling channels 44 are arranged to overlap with the cell vent cover 50 at least to a portion. As can be seen in FIG. 4, the least two top flap portions 26 and 27 elastically press the first metal sheet 31 against at least a portion of the cell vent cover 50. Thereby, the cell vent cover 50 is fixed by the inflating of the least two top flap portions 26 and 27 for forming the top cooling channel 44. Therefore, the cell vent cover 50 is fixated alone with least two top flap portions 26 and 27 being inflated to form the top cooling channel 44. Thus, fixation is simplified and a great mechanical contact is reached that improves the thermal conductivity.

Referring to FIG. 2, the top flap portions 26 and 27 elastically press the first metal sheet 31, that is, the top cooling channel 44, against an edge portion 52 of the cell vent cover 50. Thus, the edge portion 52 is held fixed while the venting function in a central region is maintained. No additional fixation is required and thermal propagation performance to the top cooling channel 44 is enhanced.

Due to the press contact, in addition, the electrode terminals 12 and 14 and the cell vent cover 50 are spatially separated, that is, spatially sealed away, from each other by each of the top cooling channels 44. This is as well illustrated in FIG. 4. Therefore, an additional sealing feature is implemented by the press contact of the first metal sheet 31 that prevents or substantially reduce the likelihood of hot gases from entering the electrode terminal area.

Further, as illustrated in the FIGS. 1 to 4, the two opposing top flap portions 26 and 27 include a cross section profile with stepped portions 38 between a flap tip portion 35 and a peripheral portion 36. The flap tip portion 35 is inwardly displaced with respect to the peripheral portion 36. The stepped portions 38 refers to a pre-configuration of the top flap portions 26 and 27 that is adapted for the height difference between where the electrode terminals 12 and 14 are located and the busbars are located compared to the flap tip portion 35. Thus, the stepped portion 38 assists to reduce the amount of inflating needed in the flap tip portion 35 to establish the press contact with the battery cell 10 or the cell vent cover 50.

The cooling channels 40, 43, and 44 are disposed between bonding areas 33 where the first metal sheet 31 and the second metal sheet 32 are roll bonded to each other. An example of a bonding area 33 is illustrated in the enlarged inset in FIG. 2. That is, the cooling channels 40, 43, and 44 are formed at unbonded areas 33′. The bonding areas 33 refer to the bonded interface between the two metal sheets 31, 32. A first thickness t1 of the first metal sheet 31 may be thinner than a second thickness t2 of the second metal sheet 32 and may improve thermal conductivity on the inner side while providing structural robustness on the outer side of the plate 30.

Referring to FIG. 2, bonding areas 33 may be formed in curved edges 37 between the side walls 22 and 23 and the two top flap portions 26 and 27. This stabilizes the upper portions of the frame 20 in the critical corner. This may be similarly performed for the curved edges 39 between the bottom member 21 and the side walls 22 and 23.

Further, referring to FIG. 1, the plurality of side walls 22, 23, 24, and 25 include two end plates 24 and 25 opposite from each other. The end plates 24, 25 in such embodiments are separate from the plate 30 and fixed to the bottom member 21 and/or the two opposite side walls 22 and 23. For example, the fixing may be performed by fixation techniques like welding, snap-fitting, bolting, or riveting.

In such embodiments, one of the two end plates, here end plate 24, are positioned axially displaced inwards with respect to an end 29 of the bottom member 21. That means, as shown in FIG. 1, the end 29 of the bottom member 21 is distanced or indented inwards from the end 29 by a displacement distance d as shown in FIG. 3.

Further, the side connection portion 47 is formed between the inwardly displaced end plate 24 and the end 29 of the bottom member 21. Thus, the side cooling channels 43 and the bottom cooling channels 40 can be continuously connected within the frame 20 by making use of the fact that the end plate 24 is separate from the plate 30 so that it can be axially displaced inwards. Further, side cooling channel ports 48 can be provided in the battery module 100 to allow the supply or the draining of coolant to and from the connected cooling channels 40 and 43. For example, the side cooling channel ports 48 may be overlapping or positioned above the side connection portion 47 in the corner of the bottom member 21.

In some embodiments, the end plates 24 and 25 are bent and extended from the bottom member 21 or are formed by deep drawing. Thus, an additional fixation and manufacturing step can be avoided because an integral frame 20 including all side walls is generated. This reduces the amount of assembly and assembly parts because additional fixation is not required.

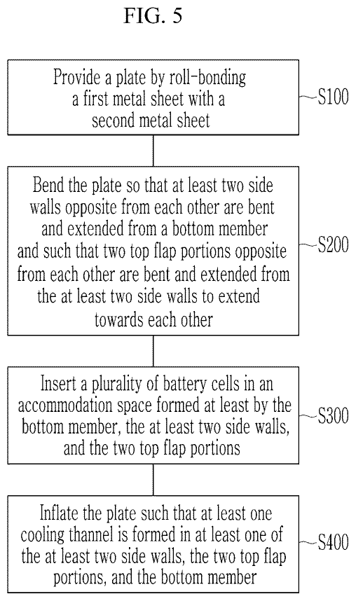

FIG. 5 shows a method of manufacturing a battery module 100, according to some embodiments of the present disclosure. The features of the method can also be obtained from the above description of the FIGS. 1 to 4 and are incorporated herein by reference.

The method includes providing (S100) a plate 30 by roll-bonding a first metal sheet 31 with a second metal sheet 32.

The method further includes bending (S200) the plate 30 so that at least two side walls 22 and 23 opposite from each other are bent and extended from a bottom member 21 and that at least two top flap portions 26 and 27 opposite from each other are bent and extended from the at least two side walls 22 and 23 to extend towards each other. Therefore, a double bending is provided for each side wall 22 and 23. The obtained geometry may refer to a C-shape. In some embodiments, the two upper top flap portions 26 and 27 are bent and extended before the side walls 22 and 23 are bent and extended. This makes the bending process easier as the bending process can be readily performed for a metal sheet because the bending location is only a shift in a plane which eases the production process and the positioning of bending devices.

The method further includes inserting (S300) a plurality of battery cells 10 in an accommodation space 28 formed at least by the bottom member 21, the at least two side walls 22 and 23 and the at least two top flap portions 26 and 27. The inserting of the battery cells 10 may include an installing of the battery cell assembly.

The method further includes inflating (S400) of the plate 30 such that at least one cooling channel 40, 43, and 44 is formed in at least one of the at least two side walls 24 and 26, the at least two top flap portions 26 and 27 and the bottom member 21 between bonding areas 33 where the first metal sheet 31 and the second metal sheet 32 are roll bonded. For the inflating, for example, a pressure generating device like a pump, a compressor or other sources that can cause high fluid pressure may be connected to an end, for example, a port, of the to-be inflated cooling channel, that is, the unbonded areas, so that a fluid pressure, for example for air or coolant, causes inflation to form the at least one cooling channel 40, 43, and 44. A limitation of the inflation can be achieved by the battery cells in a state where the battery cells 10 are installed so that the inflation of the respective channel adapts and thus compensates the tolerances of the battery cells 10. In some examples, to reach a determined shape for the at least one cooling channel 40, 43, and 44, a contour defining member may be provided which limits extension for the inflation and provides a defined shape. In order to connect the to-be-inflated cooling channel to the pressurized medium, a welded, soldered or otherwise well-connected connection to the respective channel may be a desired feature. To improve the connections, a hose sleeve or a pipe may be directly welded to the channel that is to be inflated. Thus, an easy and cost-effective method is provided where cooling channels 40, 43, and 44 can be directly integrated in one single piece. The order in which the inflating (S300) and installing (S400) are performed can be changed. For example, the order may depend on the side portion of where the inflation is performed.

In some embodiments, at least one bottom cooling channel 40 on the bottom member 21 and/or at least one side cooling channel 43 on the side wall 22 and 23 is formed by inflating. In this case, inflating (S400) for the at least one bottom cooling channel 40 and/or at least one side cooling channel 43 is performed before installing (S400) the battery cells 10 and/or the cell assembly. In this case, inflating may be performed against an auxiliary barrier. This may ensure homogeneous and equally expanded channels size. The auxiliary barrier may be removed after the inflating. Otherwise, that is, in a case without this order, it would be possible that left/right/top and bottom channels 40, 43, and 44 become inflated differently and thus would envelope a different volume.

In some other examples, a top cooling channel 44 among the at least one cooling channel is formed in at least one of the two top flap portions 26 and 27. In this case, inflating (S400) may be performed after the plurality of battery cells 10 are provided in the accommodation space 28 formed at least by the bottom member 21, the side walls 22, 23, 24, and 25 the two top flap portions 26 and 27 to elastically press the first metal sheet 31 against the plurality of battery cells 10 for forming at least one top cooling channel 44 between bonding areas 33 where the first metal sheet 31 and the second metal sheet 32 are roll bonded. Thus, a press contact can be provided because the inflating can be used to last an elastic force acting on the battery cell 10. In some examples, the inflated top flap portions 26 and 27 of the roll-bonded frame 20 can expand until the battery cell 10, for example busbar covers, the cell top and/or cell vent cover, have limited the expansion of the top cooling channels 44. Due to the elastic deformation of the top flaps of the frame as well as the self-setting of the cooling channels onto the varied counter-surfaces, a superior thermal conductivity and lasting mechanical fixation of all parts are ensured.

The two top flap portions 26 and 27 may include a cross section profile including an inwardly bent portion 34 at least in a flap tip portion 35 of the two top flap portions 26 and 27. Thus, inflating (S400) includes straightening of the inwardly bent portion 34 of the second metal sheet 32 to a straight portion 34′ by elastically pressing the first metal sheet 31 against the battery cells 10 to form the at least one top cooling channel 44. Thus, a lasting elastic tension can be provided that increases the thermal propagation and the vibration resistance. Further details can be derived from the description with respect to FIGS. 1 to 4.

Accordingly, as described above, a structurally improved battery module 100 that can be manufactured easily and at reduced costs. Embodiments provide an improved heat transfer performance over the entire battery cells 10 because the inflating of the top flap portions 26 and 27 is performed after the battery cells 10 are included in the frame 20 so that production height tolerances of the battery cells 10 are compensated for, uniform mechanical pressure and therefore superior thermal conductivity is achieved. In other words, a self-setting of the thermal contact is achieved because the top cooling channels 44 in the inflation are automatically adapting to the varying heights of the individual cells and busbars. Further embodiments allow for improvement of the heat transfer and venting properties of such a battery module 100.

### LISTING OF SOME OF THE REFERENCE NUMERALS

100 battery module
10 battery cell
12 first electrode terminal
14 second electrode terminal
20 frame/casing
21 bottom member
22, 23 side wall
24, 25 side wall/end plates
26, 27 top flap portion
28 accommodation space
29 end
30 plate
31 first metal sheet
32 second metal sheet
33 bonding area
33′ unbonded area
34 inwardly bent portion
34′ straight portion
35 flap tip portion
36 peripheral portion
37 curved edge
38 stepped portion
39 curved edge
40 bottom cooling channel
41 straight portion
42 curved cooling end portion
43 side cooling channel
44 top cooling channel
46 top connection portion
47 side connecting portion
48 side cooling channel port
49 top cooling channel port
50 cell vent cover
52 edge portion
S100 providing a plate
S200 bending the plate to form side walls and to form top flaps
S300 inserting/installing the battery cells
S400 inflating the plate
D gap
d displacement distance
t1 first thickness
t2 second thickness

What is claimed is:

1. A battery module comprising:
a plurality of battery cells; and
a frame comprising a bottom member, a plurality of side walls, and at least two top flap portions, the bottom member, the plurality of side walls and the at least two top flap portions forming an interior accommodation space configured to accommodate the plurality of battery cells,
wherein at least two side walls of the plurality of side walls that are opposite one another are bent and extended from the bottom member,
wherein the at least two top flap portions are bent and extended from the at least two side walls to extend towards each other,
wherein the at least two side walls, the at least two top flap portions, and the bottom member are formed by a plate comprising a first metal sheet on an inner side of the plate and a second metal sheet on an outer side of the plate, the first and second metal sheets being roll bonded to each other, and
wherein the plate further comprises at least one cooling channel in at least one of the at least two side walls, the at least two top flap portions and the bottom member formed between bonding areas of the first metal sheet and the second metal sheet.

2. The battery module as claimed in claim 1, wherein the at least one cooling channel comprises at least one top cooling channel formed in the at least two top flap portions, and
wherein the at least two top flap portions are configured to elastically press the first metal sheet against the plurality of battery cells by inflating the at least two top flap portions for forming at least one top cooling channel.

3. The battery module as claimed in claim 2, wherein the at least one cooling channel is arranged to overlap with an electrode terminal of the plurality of battery cells, and the at least two top flap portions are configured to elastically press the first metal sheet against the electrode terminal of the plurality of battery cells by the inflating of the at least two top flap portions to form the at least one top cooling channel.

4. The battery module as claimed in claim 3, further comprising:
a cell vent cover on the plurality of battery cells; and
a gap formed between the at least two top flap portions extending towards each other, the gap overlapping with the cell vent cover.

5. The battery module as claimed in claim 4, wherein the at least one top cooling channel is arranged to overlap with the cell vent cover, and the at least two top flap portions are configured to elastically press the first metal sheet against at least a portion of the cell vent cover to fix the cell vent cover by the inflating of at least two top flap portions for forming the at least one top cooling channel.

6. The battery module as claimed in claim 5, wherein the at least two top flap portions are configured to elastically press the first metal sheet against an edge portion of the cell vent cover.

7. The battery module as claimed in claim 5, wherein the electrode terminal and the cell vent cover are separated from each other at least one top cooling channel.

8. The battery module as claimed in claim 1, wherein the at least two top flap portions comprise a cross section profile with stepped portions between a flap tip portion and a peripheral portion, the flap tip portion being inwardly displaced with respect to the peripheral portion.

9. The battery module as claimed in claim 1, wherein bonding areas are formed in curved edges between the side walls and the at least two top flap portions.

10. A method of manufacturing a battery module, wherein the method comprises:
providing a plate by roll-bonding a first metal sheet with a second metal sheet;
bending the plate so that at least two side walls opposite from each other are bent and extended from a bottom member and such that two top flap portions opposite from each other are bent and extended from the at least two side walls to extend towards each other;
inserting a plurality of battery cells in an accommodation space formed at least by the bottom member, the at least two side walls, and the two top flap portions; and
inflating the plate such that at least one cooling channel is formed in at least one of the at least two side walls, the two top flap portions, and the bottom member between bonding areas of the first metal sheet and the second metal sheet.

11. The method of manufacturing as claimed in claim 10, wherein the at least one cooling channel comprises at least one top cooling channel formed in at least one of the two top flap portions, and
wherein the inflating comprises:
inflating, after the plurality of battery cells are installed in the accommodation space formed at least by the bottom member, the two top flap portions to elastically press the first metal sheet against the plurality of battery cells for forming at least one top cooling channel between bonding areas of the first metal sheet and the second metal sheet.

12. The method as claimed in claim 10, further comprising:
providing a cell vent cover comprising venting valves formed on the plurality of battery cells; and
extending the two top flap portions towards each other so that a gap is formed which overlaps with the cell vent cover.

13. The method as claimed in claim 10, wherein two top flap portions comprise a cross section profile comprising an inwardly bent portion of a flap tip portion of the two top flap portions that is bent towards the plurality of battery cells in a state prior to inflating, and
the inflating comprises straightening of inwardly bent portion of the second metal sheet to a straight portion by elastically pressing the first metal sheet against the battery cells to form the at least one top cooling channel.

14. A battery system comprising the battery module as claimed in claim 1.

15. A vehicle comprising the battery system as claimed in claim 14.
